(19) United States
(12) Patent Application Publication
(10) Pub. No.: US 2008/0151730 A1
(43) Pub. Date: Jun. 26, 2008

(54) Optical recording and reading method, optical recording and reading apparatus, and optical recording medium

(75) Inventors: Takashi Kikukawa, Tokyo (JP); Koji Mishima, Tokyo (JP); Hidetake Itoh, Tokyo (JP)

Correspondence Address: MATHEWS, SHEPHERD, MCKAY, & BRUNEAU, P.A., 29 THANET ROAD, SUITE 201, PRINCETON, NJ, 08540, US

(73) Assignee: TDK Corporation

(21) Appl. No.: 12/004,866

(22) Filed: Dec. 21, 2007

(30) Foreign Application Priority Data
Dec. 22, 2006 (JP) 2006-345753

(51) Int. Cl. G11B 3/74

(52) U.S. Cl. 369/94

(57) ABSTRACT

An optical recording and reading method capable of enhancing the design flexibility of recording layers of an optical recording medium and performing accurate optical recording and reading operations. The optical recording and reading method is one for recording and reading an optical recording medium having three or more recording layers by irradiating the same with laser light using an optical recording and reading apparatus. When an optical recording medium is mounted on the optical recording and reading apparatus, the positions of the recording layers of the optical recording medium are measured using the laser light.

### BACKGROUND OF THE INVENTION

1. Field of the Invention

The present invention relates to an optical recording medium having a plurality of recording layers capable of reading data with laser light, and an optical recording and reading method for recording and reading this optical recording medium.

2. Description of the Related Art

CD-DA, CD-ROM, CD-R, CD-RW, DVD-ROM, DVD-R, DVD±RW, DVD-RAM, and the like are now in widespread use for viewing digital moving image contents and recording digital data. Meanwhile, in order to cope with higher definition moving images and handle digital data of greater size, so-called next-generation DVD which can store moving images and data of greater sizes than CDs and existing DVDs have been moving toward the commercial stage. Recording media based on Blu-ray Disc (BD) standard, being one of the standards for next-generation DVDs, have a capacity of 25 GB per layer using an objective lens with a numerical aperture of 0.85. HD-DVD, another standard for next-generation DVD, uses an objective lens with a numerical aperture of 0.65 and has a data capacity of 15 to 20 GB per layer.

Both moving images and computer data are expected to significantly increase in size in the future. Even with the next-generation DVD standards, so-called multilayered optical recording techniques have been proposed in order to increase the number of recording layers, thereby providing greater disc capacity. Take, for example, a BD disc. A technique of achieving an extremely large capacity, as high as 200 GB, by forming six to eight recording layers on one side of the disc as been proposed (see I. Ichimura et. al., Appl. Opt., 45, 1794-1803 (2006), and K. Mishima et. al., Proc. of SPIE, 6282, 62820I (2006)).

BD discs having two recording layers have already been released into the market. In the recording media based on the double-layer BD standards, the positions of the respective recording layers are defined by the standards. One of the two recording layers is arranged at a position 100 μm away from a light incident surface. The other recording layer is arranged at a position that is approximately 25 μm closer to the light incident surface than the foregoing recording layer is (being at a position 75 μm away from the light incident surface).

Optical recording and reading apparatuses that support the BD standards have only to focus on the position 100 μm away from the light incident surface if a single-layer recording medium is loaded, and focus on the positions 75 μm and 100 μm away from the light incident surface if a double-layer recording medium is loaded. That is, the apparatuses can reliably record and read the recording media as long as they have an optical pickup mechanism conforming to the disc standards.

It should be noted that optical recording media having three or more recording layers are more susceptible to crosstalk, surface fingerprints, and the like, and thus are more complicated in design. In order to obtain favorable signal characteristics, an L0 recording layer, or the lowest recording layer, and an L1 recording layer adjoining this L0 recording layer are preferably spaced as far away from each other as possible. If the interlayer distance is too large, however, a recording layer lying closest to the light incident surfaces comes so close to this light incident surface that it becomes susceptible to fingerprints and the like. In order to reduce crosstalk between the three or more recording layers, the recording layers must also be arranged at different spacings. In the cases of optical recording media having three or more layers, the factors having an impact on the signal quality are therefore complicated, and include the selection of interlayer distances and spacer materials. As a result, there has been a problem in that it is difficult to standardize the position of each recording layer across a plurality of manufacturers.

When the positions of the respective recording layers are determined arbitrarily by manufacturers, however, the optical recording and reading apparatus cannot identify the positions of the respective recording layers of the Blu-ray Discs loaded. Accordingly, there may be a problem in that it takes time for the device to achieve focus.

### SUMMARY OF THE INVENTION

The present invention has been developed in view of the foregoing problems. It is thus an object of the present invention to provide an optical recording and reading method capable of enhancing the design flexibility of an optical recording medium and reducing operation delays and errors occurring during optical recording and reading.

The inventors have made intensive studies and achieved the foregoing object with the following means.

A first aspect of the present invention is an optical recording and reading method for recording and reading an optical recording medium having three or more recording layers by irradiating the same with laser light in an optical recording and reading apparatus, the method comprising the step of measuring positions of the recording layers of an optical recording medium using the laser light when the optical recording medium is mounted on the optical recording and reading apparatus.

In this optical recording and reading method according to the first aspect of the present invention, wherein an objective lens provided in the optical recording and reading apparatus is moved to shift a beam spot of the laser light in the stacking direction of the layers, thereby measuring the positions of the recording layers using reflected light of the laser light.

In this optical recording and reading method according to the first aspect of the present invention, wherein the positions of the recording layers are measured based on an intensity of the reflected light of the laser light.

In this optical recording and reading method according to the first aspect of the present invention, wherein the positions of the recording layers are measured using a focus error signal pertaining to the laser light.

In this optical recording and reading method according to the first aspect of the present invention, wherein the recording layers of the optical recording medium have a dedicated measurement area in which the optical recording and reading apparatus measures the positions of the recording layers using the laser light.

In this optical recording and reading method according to the first aspect of the present invention, wherein the dedicated measurement area has a flat surface that is greater than the beam spot of the laser light.

In this optical recording and reading method according to the first aspect of the present invention, wherein: position information on the recording layers of the optical recording medium is recorded on the recording layers in advance; and when the optical recording medium is mounted, the optical recording and reading apparatus reads the position information recorded on the optical recording medium, and measures the positions of the recording layers as well.

In this optical recording and reading method according to the first aspect of the present invention, wherein: the optical recording and reading apparatus stores identification information for identifying a plurality of optical recording media and position information on recording layers of the optical recording media in advance; the identification information is recorded on the optical recording media in advance; and when an optical recording medium is mounted on the optical recording and reading apparatus, the optical recording and reading apparatus reads the identification information recorded on the optical recording medium and refers to the position information based on the identification information, as well as measures the positions of the recording layers.

A second aspect of the present invention is an optical recording and reading apparatus for recording and reading an optical recording medium having three or more recording layers by irradiating the same with laser light, the apparatus comprising measuring means for measuring positions of the recording layers of an optical recording medium using the laser light when the optical recording medium is mounted on the optical recording and reading apparatus.

A third aspect of the present invention is an optical recording medium having three or more recording layers capable of recording and reading through irradiation of laser light, the recording layers having a dedicated measurement area intended for measuring the positions of the recording layers through the irradiation of the laser light.

According to the present invention, it is possible to obtain the superior effect of enhancing the flexibility of design with respect to the positions of the recording layers of optical recording media, and achieve high-quality recording and reading operations on various types of optical recording media.

### BRIEF DESCRIPTION OF THE DRAWINGS

The above and other objects, features and advantages of the present invention will become apparent from the following description and appended claims, taken in conjunction with the accompanying drawings.

FIG. 1 is a diagram showing the general configuration of an optical recording medium and an optical recording and reading apparatus according to a first embodiment of the present invention;

FIGS. 2A and 2B are enlarged views showing the configuration of the optical recording medium;

FIGS. 3A and 3B are diagrams showing the information holding form of the optical recording medium;

FIG. 4 is a diagram showing the groove structure of the optical recording medium;

FIGS. 5A and 5B are diagrams showing how the optical recording and reading apparatus measures the positions of the recording layers;

FIG. 6 is a diagram showing the general configuration of an optical recording medium and an optical recording and reading apparatus according to a second embodiment of the present invention;

FIG. 7 is a diagram showing an example of identification information and position information to be held in the optical recording and reading apparatus;

FIGS. 8A and 8B are diagrams showing the information holding form of the optical recording medium; and

FIG. 9 is an enlarged view showing another structure of the dedicated measurement area of the optical recording medium.

### DETAILED DESCRIPTION OF THE PREFERRED EMBODIMENTS

Next, embodiments of the present invention will be described in detail with reference to the drawings.

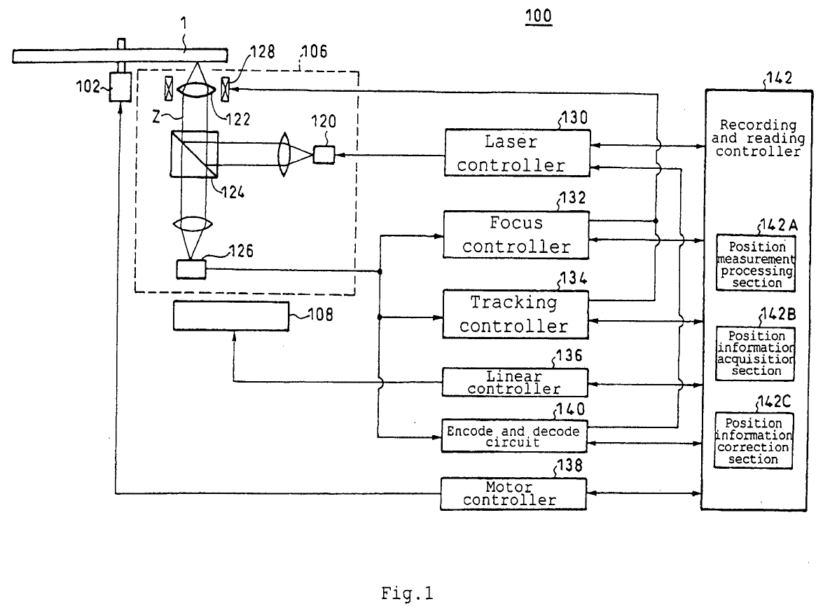

FIG. 1 shows an optical recording medium 1 and an optical recording and reading apparatus 100 for that executes the optical recording and reading method according to a first embodiment of the present invention. This optical recording and reading apparatus 100 includes a motor 102, an optical pickup 106, and a linear drive mechanism 108. The motor 102 rotationally drives the optical recording medium 1. The optical pickup 106 irradiates the optical recording medium 1 with a beam spot to optically record and read information. The linear drive mechanism 108 drives the optical pickup 106 linearly in the radial direction of the optical recording medium 1. It should be noted that this optical recording medium 1 is a multilayered recording medium having a plurality of recording layers for recording information.

The optical pickup 106 is provided with a laser light source 120, an objective lens 122, a half mirror 124, a photo-detection device 126, and a lens drive coil 128. The optical pickup 106 can adjust the focus of the laser light Z on the recording layer of the optical recording medium 1.

The laser light source 120 is a semiconductor laser which generates the laser light Z for both recording and reading The objective lens 122 forms the minute beam spot by narrowing the focus of the laser light Z and irradiates the specific recording layer with it. The half mirror 124 takes out reflected light from the recording layer and directs it to the photo-detection device 126. The photo-detection device 126, being a photodetector, receives the reflected light of the laser light Z and converts it into an electrical signal. The lens drive coil 128 moves the objective lens 122 to the direction of the optical axis and to a tracking direction.

Furthermore, the optical recording and reading apparatus 100 is provided with a laser controller 130, a focus controller 132, a tracking controller 134, a linear controller 136, a motor controller 138, a encode and decode circuit 140, and an optical recording and reading controller 142. The laser controller 130 controls the driving of the laser light source 120 of the optical pickup 106 on the basis of directions received from the encode and decode circuit 140 and the optical recording and reading controller 142. The focus controller 132 detects a focus error based on the electrical signal sent from the photo-detection device 126 and controls the drive of the lens drive coil 128 in a focus direction (being the direction of the optical axis) with the use of the focus error. The tracking controller 134 detects a tracking error on the basis of the electrical signal sent from the photo-detection device 126 and controls the drive of the lens drive coil 128 in the tracking direction with the use of the tracking error. The tracking controller 134 also has the function of transmitting tracking error information to the optical recording and reading controller 142 and to the linear controller 136. Accordingly, it is possible to make the beam spot follow a recording track using the tracking control of the lens drive coil 128 and the linear drive of the whole optical pickup 106 using the linear controller 136. The linear controller 136 controls the drive of the linear drive mechanism 108 which is composed of a linear motor and the like, and slides the optical pickup 106 in the radial direction of the optical recording medium 1. The motor controller 138 controlling the rotational speed of the motor 102 rotates the optical recording medium 1 using the zone CLV method in this instance. A CLV method is a recording method by which the optical pickup 106 moves with constant linear velocity on the optical recording medium 1, in other words, the number of revolutions per minute is gradually reduced from the inner circumference to the outer circumference of the optical recording medium 1. In addition to this, the zone CLV divides the recording layer of the optical recording medium 1 into several areas (zones) from the inner circumference outwards and information is recorded by the CLV method on a zone-by-zone basis.

The encode and decode circuit 140 has a encode function and a decode function. As the decode function, the encode and decode circuit 140 decodes the electrical signal sent from the photo-detection device 126 into a digital signal and transmits the digital signal to the optical recording and reading controller 142. As the encode function, the encode and decode circuit 140 subjects a digital signal for recording sent from the optical recording and reading controller 142 to a pulse modulation and transmits an electrical signal after modulation to the laser controller 130. The optical recording and reading controller 142 for integrally controlling the entire control device controls various kinds of controllers, drivers, and the like by using a CPU and a buffer memory, which are not especially illustrated, and also carries out the input and output of recording and reading information to a host computer.

The optical recording and reading controller 142 also includes a position measurement processing section 142A, a position information acquisition section 142B, and a position information correction section 142C.

The position measurement processing section 142A measures the positions of the recording layers of the optical recording medium 1 using the optical pickup 106 (laser light Z) when the optical recording medium 1 is mounted. Specifically, it uses the lens drive coil 128 to move the objective lens 122 in the direction of the optical axis while detecting at least either the intensity of reflected light of the laser light Z or a focus error signal, thereby measuring the positions of the recording layers. It should be appreciated that both the intensity of the reflected Light and the focus error signal may be measured.

To measure the positions of the recording layers based on the intensity of the reflected light, an electronic signal transmitted from the photo-detection device 126 is used. When the beam spot of the laser light Z shifts in the thickness direction of the optical recording medium 1, the intensity of the reflected light changes. The change in intensity peaks each time a recording layer is passed. The positions of the beam spot where the intensity peaks therefore correspond to the positions of the respective recording layers.

To measure the positions of the recording layers based on focus error, a focus error signal transmitted from the focus controller 132 is used. The focus error signal traces an S-curve each time a recording layer is passed. The symmetric property of this S-shaped curve is thus utilized to calculate the centers of the S-shapes, which are considered to be the positions of the respective recording layers. Then, the position measurement processing section 142A uses both the intensity of the reflected light and the focus error signal to measure the positions of the recording layers independently, and collates the measurements in order to exclude obvious measurement errors when determining the positions of the recording layers. While the present embodiment deals with the case of using both the intensity of the reflected light and the focus error, either one of these may be used for measurement. Other techniques capable of measuring the positions of the recording layers may also be used.

The position information acquisition section 142B reads the position information that is recorded on the optical recording medium 1 in advance, when the optical recording medium 1 is mounted. The position information correction section 142C calculates the optimum corrected position information using both the positions of the recording layers measured by the position measurement processing section 142A and the position information read from the optical recording medium 1. This corrected position information is used to perform a focus control on an intended recording layer

In the optical recording and reading apparatus 100, the wavelength λ of the laser light Z is set to a value in the range of 400 to 410 nm and the initial reading power of the laser light Z is set to a value in the range of 0.3 to 2.0 mW. The numerical aperture NA of the objective lens 122 in the optical pickup 106 is set to a value in the range of 0.70 to 0.90. Accordingly, the spot diameter (λ/NA) of the laser light Z is set to a value in the range of 444 nm to 586 nm.

In order to record information on the optical recording medium 1, the laser light Z is generated from the laser light source 120 by the recording power and the specific recording layer of the optical recording medium 1 is irradiated with the beam spot. In order to read the information, on the other hand, the laser light Z is generated from the laser light source 120 by the reading power and the recording layer of the optical recording medium 1 is irradiated with the laser light Z. In the case of both recording and reading, the laser light Z which is reflected from the recording layer and is taken out through the optical pickup 106 becomes an electrical signal in the photo-detection device 126. The electrical signal becomes a digital signal by passing through the encode and decode circuit 140.

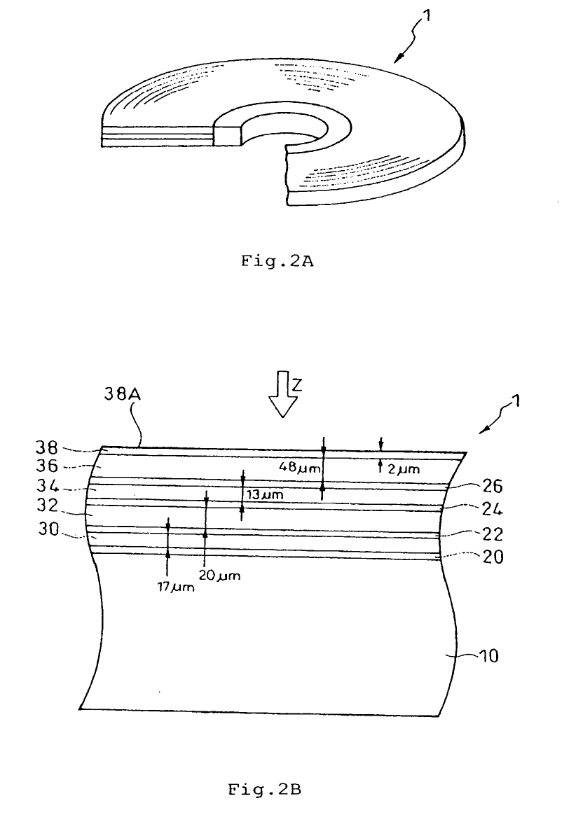

A description will now be given of the optical recording medium 1 to be read by the optical recording and reading apparatus 100. This optical recording medium I is a disc-shaped medium as shown in FIG. 2A, having an outer diameter of approximately 120 mm and a thickness of approximately 1.2 mm. As shown enlarged in FIG. 2B, the optical recording medium 1 is a multilayered medium having four recording layers. The optical recording medium 1 is configured to include a substrate 10, an L0 recording layer 20 being a basic recording layer, a first spacer layer 30, an L1 recording layer 22 being a first multilayered recording layer, a second spacer layer 32, an L2 recording layer 24 being a second multilayered recording layer, a third spacer layer 34, an L3 recording layer 26 being a third multilayered recording layer, a cover layer 36, and a hard coat layer 38, which are stacked in this order.

The substrate 10 is a disc-shaped member with a thickness of approximately 1.1 mm. The material of the substrate 10 may be made of various materials such as, for example, glass, ceramic, and resin. A polycarbonate resin is used in this instance. The resin may also be an olefin resin, an acrylic resin, an epoxy resin, a polystyrene resin, a polyethylene resin, a polypropylene resin, a silicon resin, a fluorine resin, an ABS resin, an urethane resin, or the like in addition to the polycarbonate resin. Of the resins described above, the polycarbonate resin and the olefin resin are preferable due to the fact that they are easily processed and molded. In the surface of the substrate 10 on the side on which the recording layer is located, a groove, a land, a pit row, and the like are formed in accordance with the desired application of the optical recording medium.

The first to third spacer layers 30, 32, and 34, the cover layer 36, and the hard coat layer 38 are each optically transparent, and transmit laser light incident from exterior. The laser light Z incident on the light incident surface 38A of the hard coat layer 38 can thus be used to perform optical recording and reading of information on all the L0 to L3 recording layers 20, 22, 24, and 26.

The first to third spacer layers 30, 32, and 34 which are stacked between the L0 to L3 recording layers 20, 22, 24, and 26 have the function of separating each of the recording layers 20, 22, 24, and 26. A groove (land), a pit row, and the like are formed in the surface of each of the spacer layers 30, 32, and 34 on the light incident surface 38A side. Various materials are available to form the first to third spacer layers 30, 32, and 34 but, as described above, it is necessary to use a material with optical transparency in order to allow the laser light Z to pass therethrough. It is also preferable to use, for example, an UV-curable acrylic resin.

In the optical recording medium 1, the thickness of the first spacer layer 30 is set at 17 μm, the thickness of the second spacer layer 32 is set at 20 μm, and the thickness of the third spacer layer 34 is set at 13 μm. Varying the thicknesses of the spacer layers 30, 32, and 34 from one another, as described above, makes it possible to reduce the interference of a read signal and hence reduce noise in a readout signal. The thickness of the hard coat layer 38 is set at 2 μm and the thickness of the cover layer 36 is set at 48 μm.

In other words, in this optical recording medium 1, the distance from the light incident surface 38A to the L3 recording layer 26 is approximately 50 μm. The distance from the light incident surface 38A to the L2 recording layer 24 is approximately 63 μm. The distance from the light incident surface 38A to the L1 recording layer 22 is approximately 83 μm. The distance from the light incident surface 38A to the L0 recording layer 20 is approximately 100 μm. The L0 recording layer 20, or a basic recording layer, is located at a position in the range of 90 μm to 110 μm away from the light incident surface 38A and has a recording capacity of 25 GB. The basic recording layer thus complies with the Blu-ray Disc standards. The multilayered recording layers, or the L1 to L3 recording layers 22, 24, and 26, are arranged in parallel with the basic recording layer (L0 recording layer 20). That is, the multilayered recording layers are added to the basic recording layer in order to configure the optical recording medium 1 into a multilayered structure.

When optically recording or reading information on/from the L0 recording layer 20, the L0 recording layer 20 is irradiated with the laser light Z through the L1 to L3 recording layers 22, 24, and 26. Similarly, when optically recording or reading information on/from the L1 recording layer 22, the L1 recording layer 22 is irradiated with the laser light Z through the L2 and L3 recording layers 24 and 26. When optically recording or reading information on/from the L2 recording layer 24, the L2 recording layer 24 is irradiated with the laser light Z through the L3 recording layer 26. When optically recording or reading information on/from the L3 recording layer 26, the L3 recording layer 26 is directly irradiated with the laser light Z without passing through the other recording layers.

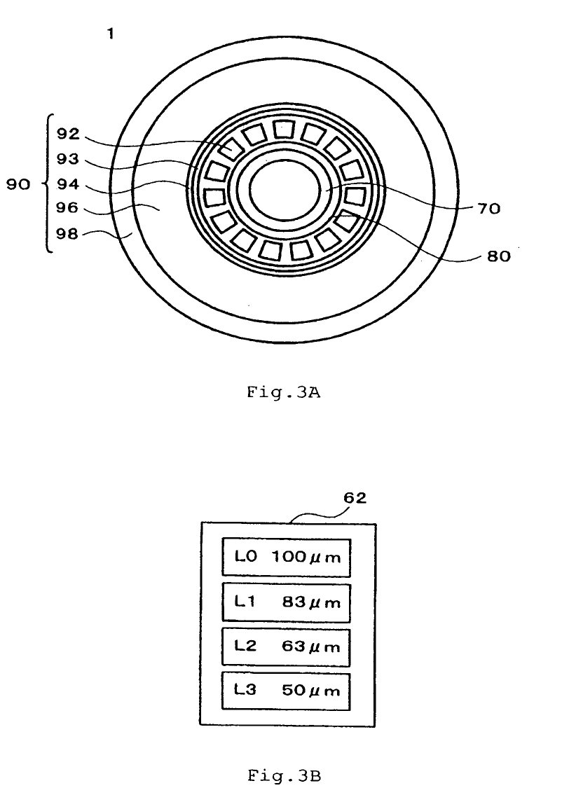

As shown in FIG. 3A, the optical recording medium 1 is divided into a clamping area 70, a transition area 80, an information area 90, and the like. Each of the recording layers 20, 22, 24, and 26 corresponds to the information area 90. The information area 90 is further divided into a dedicated measurement area 93, a lead-in area 94, a data area 96, a lead-out area 98, etc. It should be noted that the basic recording layer or L0 recording layer 20 also has burst cutting areas (BCAs) 92 inside its dedicated measurement area 93. While the present embodiment deals with the case where the lead-in area 94, the data area 96, and the lead-out area 98 are arranged in this order from the inside to the outside, these areas may be arranged in reverse order depending on the direction of information recording (spiral direction). That is, when recording information from the outside to the inside, the lead-in area 94, the data area 96, and the lead-out area 98 are arranged in this order from the outside to the inside.

As shown in FIG. 3B, the optical recording medium 1 is also configured so that position information 62 on the L0 to L3 recording layers 20, 22, 24, and 26 is recorded on the lead-in area 94 of each of the recording layers 20, 22, 24, and 26. In the present embodiment, the position information 62 includes information on the distances of the respective recording layers from the light incident surface 38A, such as the L0 recording layer 20: 100 μm, the L1 recording layer 22: 83 μm, the L2 recording layer 24: 63 μm, and L3 recording layer 26: 50 μm. While the present embodiment deals with the case where the position information 62 is recorded on the lead-in area 94, it may be recorded on the lead-out area 98 or the BCAs 92. Information such as the recording densities of the respective recording layers 20, 22, 24, and 26 is recorded on the burst cutting areas (BCAs) 92, the lead-in area 94, or the lead-out area 98 in advance.

The dedicated measurement area 93 has a flat surface that is greater than the beam spot of the laser light Z. The flat surface refers to a surface that is free from grooves, lands, pits, and the like having widths smaller than the diameter of the beam spot. This makes it possible to prevent the intensity of the reflected light and the focus error signal from deviating due to pits and projections on the recording layers when the position measurement processing section 142A measures the positions of the L0 to L3 recording layers 20, 22, 24, and 26 using the optical pickup 106 (laser light Z). As a result, it becomes possible to accurately measure the positions of the recording layers.

The information holding form of the L0 to L3 recording layers 20, 22, 24, and 26 is the so-called recording type in which writing by a user is possible. The recording type, to be more specific, is divided into a write-once read-many type in which, if data has been written once in an area, new data is not rewritable in that area and a rewritable type in which, even if data has been written in an area, the data is erased and new data is rewritable. The data holding form of the L0 to L3 recoding layers 20, 22, 24, and 26 can be of either type. It should be noted, however, that the data holding forms of the recording layers 20, 22, 24, and 26 may also be different from one another.

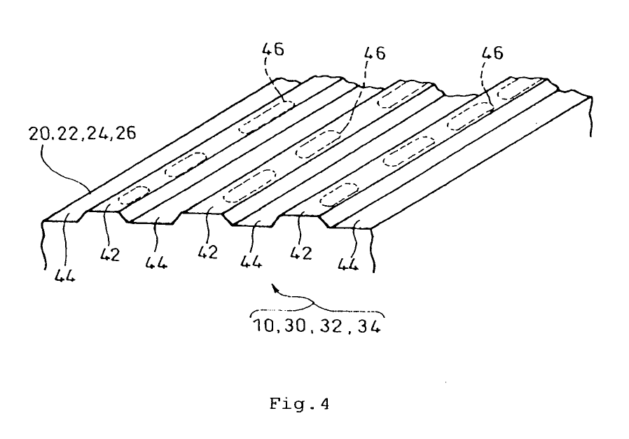

As shown in FIG. 4, the substrate 10 and the first to third spacer layers 30, 32, and 34 have a spiral groove 42 (land 44) formed in/on their surfaces. These grooves 42 make the recording tracks of the respective recording layers 20, 22, 24, and 26. The grooves 42 of the L0 recording layer 20 and the L2 recording layer 24 are formed to spiral in the same direction. The grooves 42 of the L1 recording layer 22 and the L3 recording layer 26 are formed to spiral in the direction opposite from those of the L0 recording layer 20 and the L2 recording layer 24 are. The L0 to L3 recording layers 20, 22, 24, and 26 are provided with respective recording films. The grooves 42 function as guide tracks for the laser light Z when recording data. The laser light Z, traveling along a groove 42, is modulated in energy intensity so that recording marks 46 are formed on the groove 42 of the recording layer 20, 22, 24, or 26. In data holding form of write-once type, these recording marks 46 are formed in an irreversible fashion and are thus not erasable. In data holding form of rewritable type, on the other hand, the recording marks 46 are formed in a reversible fashion, and can thus be erased and formed again. While the present embodiment deals with the case where the recording marks 46 are formed on the grooves 42, they may be formed on the lands 44 or both on the grooves 42 and the lands 44. The embodiment will deal with recording layers of recordable types, whereas the present invention may also be applied to recording layers of read only type. As mentioned previously, this groove 42 (land 44) is not formed in/on the dedicated measurement areas 93 of the recording layers 20, 22, 24, and 26.

A description will now be given of the method by which this optical recording and reading apparatus 100 optically records and reads the optical recording medium 1.

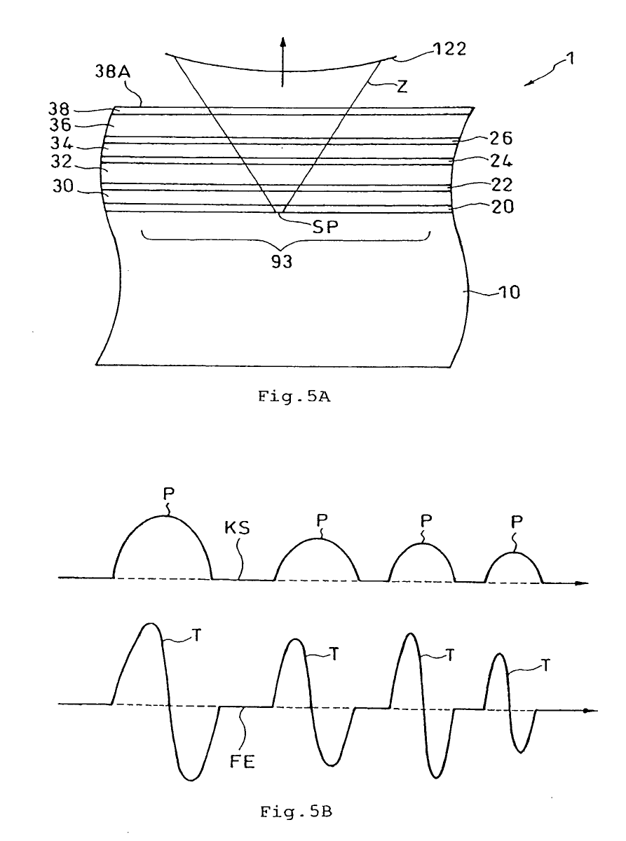

When the optical recording and reading controller 142 receives recording information from the host computer, it controls the laser controller 130, the focus controller 132, the tracking controller 134, the linear controller 136, the motor controller 138, and the like in order to start recording. The optical recording and reading controller 142 also measures the positions of the recording layers 20, 22, 24, and 26 using the position measurement processing section 142A. Specifically, as shown in FIG. 5A, the objective lens 122 is radially positioned on to the flat dedicated measurement area 93 before the objective lens 122 is moved in the direction of the optical axis. With the movement of the objective lens 122, the beam spot SP of the laser light Z shifts in the stacking direction from the L0 recording layer 20 to the L3 recording layer 26. Consequently, as shown in FIG. 5B, the position measurement processing section 142A acquires an intensity signal KS and a focus error signal FE which is transmitted from the photo-detection device 126 and the focus controller 132. The intensity signal KS shows a peak P each time any one of the recording layers 20, 22, 24, and 26 is passed. Thus, the positions of the beam spot SP when the peaks P are detected correspond to the measured positions of the respective recording layers 20, 22, 24, and 26. The focus error signal FE traces an S-curve T each time any one of the recording layers 20, 22, 24, and 26 is passed. Since each of these S-curves T is symmetrical, the center points of these S-curves T indicate the measured positions of the respective recording layers 20, 22, 24, and 26. These two types of measured positions are therefore collated in order to exclude obvious measurement errors before the two types of measured positions are averaged to determine the measured positions of the recording layers 20, 22, 24, and 26.

Subsequently, the position information acquisition section 142B reads the BCAs 92 and the lead-in area 94 in the information area 90 of the L0 recording layer 20 of the optical recording medium 1 in succession, and refers to the position information 62 recorded on the lead-in area 94. Consequently, the optical recording and reading apparatus 100 acquires the position information on the recording layers 20, 22, 24, and 26 directly from the optical recording medium 1.

Next, the position information correction section 142C calculates corrected position information by utilizing both the position information 62 read from the optical recording medium 1 by the position information acquisition section 142B and the measured positions of the respective recording layers 20, 22, 24, and 26 acquired by the position measurement processing section 142A. Specifically, the position information 62 read from the optical recording medium 1 is corrected with reference to the measured positions, thereby determining corrected position information.

Suppose that the L3 recording layer 26 is selected as the recording layer to start recording information on. Based on the corrected position information acquired in advance, the objective lens 122 is focus-controlled in the direction of the optical axis so that the laser light Z comes into focus on this L3 recording layer 26. The corrected position information reflects the positions of the respective recording layers 20, 22, 24, and 26 with extremely high precision, and the focus control taking account of this information can thus establish precise focusing from the beginning of the process. The L3 recording layer 26 is then subjected to a test recording operation. After completion of the test, the optical pickup 106 is positioned on a target recording track to start recording from, and the recording is started. This can consequently reduce the focus time when starting recording on the L3 recording layer 26 significantly.

When recording, the recording information provided from the host computer is decoded into a pulsed signal by the encode and decode circuit 140, and input to the laser controller 130. As a result, the laser light source 120 set at a particular recording power emits a predetermined laser light Z by pulse irradiation and its beam spot is incident upon the L3 recording layer 26 in order to record the information.

During the recording operation, the reflected light of the laser light Z through the half mirror 124 is converted into an electrical signal by the photo-detection device 126. With reference to this electrical signal, the focus controller 132, the tracking controller 134, and the linear controller 136 exercise control over the optical pickup 106 and the linear drive mechanism 108 whenever necessary. For example, the focus controller 132 detects a focus error continuously, and controls the lens drive coil 128 in order to move the objective lens 122 into focus in the direction of the optical axis when the beam spot on the L3 recording layer 26 goes out of focus. The tracking controller 134 detects a tracking error, i.e., whether or not the beam spot follows the groove 42 properly. When it goes off the groove 42, the tracking controller 134 controls the lens drive coil 128 and moves the entire optical pickup 106 through the linear controller 136 so as to follow the groove 42. This makes it possible to accurately record information within the groove 42.

Subsequently, when the data area 96 of the L3 recording layer 26 is filled with information, the recording shifts to the L2 recording layer 24. In this instance, the objective lens 122 is focus-controlled in the direction of the optical axis based on the corrected position information acquired in advance, so as to focus the laser light Z on this L2 recording layer 24. The laser light Z can be focused almost exactly from the beginning of the process. The L2 recording layer 24 is then subjected to a test recording operation. After completion of the test, the optical pickup 106 is positioned on a target recording track to start recording from, and the recording is started at a predetermined recording density. In this way, optical recording and reading operations are performed on/from the L0 to L3 recording layers 20, 22, 24, and 26.

According to the optical recording and reading method of this first embodiment, even when a multilayered optical recording medium 1 having three or more layers is mounted, it is possible to perform quick focus control on the individual recording layers 20, 22, 24, and 26. In particular, since the positions of the recording layers 20, 22, 24, and 26 of the optical recording medium 1 are actually measured before starting recording, high-precision focus control can be exercised from the beginning of the process. Furthermore, since the position information 62 recorded on the optical recording medium 1 is used in combination, it is possible to exclude measurement errors from the actual measurements. In addition, the optical recording medium 1 has dedicated measurement areas 93, which are flat surfaces. These dedicated measurement areas 93 can be irradiated with the laser light Z in order to accurately detect the positions of the recording layers 20, 22, 24, and 26.

The use of the present embodiment also allows manufacturers to determine the positions of the respective recording layers of the optical recording medium 1 freely. Consequently, the design flexibility of the optical recording medium 1 can be enhanced independently of the optical recording and reading apparatus 100. For example, as in this optical recording medium 1, if different individual manufactures include some contrivance so as to change the distance between the recording layers 20, 22, 24, and 26, the optical recording and reading apparatus 100 can obtain the position of each of the recording layers 20, 22, 24, and 26 every time the optical recording medium 1 is changed, so that it becomes possible to precisely carry out the optical recording and reading operations.

Take, for example, an optical recording medium having three or more layers. When a certain recording layer is under reading operation, reflected light from adjoining recording layers may often get into the optical pickup 106 to produce noise, resulting in a drop in signal quality. Accordingly, a manufacturer may desire to keep a certain distance between the layers in order to reduce crosstalk from the adjoining layer or layers. Furthermore, as described above, manufactures want to avoid duplicating the thickness of each spacer layer as much as possible due to confocal crosstalk caused by multiple reflections among the three or more recording layers. Moreover, if the recording layers are given different reflectivities, recording layers that adjoin a recording layer of the highest reflectivity (typically the L0 recording layer 20 which lies the farthest away from the light incident surface 38A) are preferably kept as far apart as possible since the reflected light from this recording layer is high in intensity. Consequently, the interlayer distances between the three or more layers of the optical recording medium 1 must be determined in consideration of various factors such as the materials forming the recording layers and the spacer layers, and the method of surface treatment on the light incident surface 38A.

The closer the recording layers are to the light incident surface 38A, the more sharply the signal quality of the optical recording medium 1 changes depending on scratches, dust, fingerprints, and other stains on the light incident surface 38A. Accordingly, in order to stabilize the signal quality, the cover layer 36 also needs a certain predetermined thickness. Conversely, since any spherical aberration needs correcting in accordance with the depth of each recording layer from the light incident surface 38A, maintaining the distance between the recording layers has, to a certain degree, an upper limit in consideration of the range of spherical aberration correction. When manufacturing the optical recording medium 1, a significant amount of warpage and tilt can occur in its outer shape, so that coma aberration due to a shape error becomes an important factor for determining disc structure. To be more specific, when λ represents the wavelength of a laser, NA represents the numerical aperture of the lens, and t represents the thickness of a cover layer, the coma aberration ∝ (t×NA³)/λ. As the cover layer 36 increases in thickness t, the coma aberration increases proportionately and thus affects the tilt margin significantly.

Therefore, in the case of an optical recording medium 1 having three or more layers, the thickness of the cover layer and the spacer layers and the like have an extremely large effect on the signal characteristics. Accordingly, even if an optimum recording layer is developed, when the thicknesses of the cover layer and the spacer layers are fixed as a standard, there may be a problem in that a recording layer with superior characteristics cannot be adopted because of a mismatch with these thicknesses.

In the case of the optical recording medium 1 having three or more layers as described above, it is, in fact, difficult to standardize the positions of the recording layers among multiple manufacturers. Then, the optical recording and reading method of the present embodiment can be employed to make the optical recording and reading apparatus 100 fully compatible even if the individual manufactures design the thicknesses of the spacer layers and the characteristics of the recording layers without restraint. As a result, it is possible to broaden the popularity of the high-performance optical recording medium 1.

It should be appreciated that, in the present embodiment, the optical recording medium 1 stores the position information 62 on the L0 recording layer 20 which lies in the range of 90 μm to 110 μm away from the surface. Any optical recording and reading apparatus 100 conforming to Blu-ray Disc standards can thus read the position information 62 without fail. This optical recording medium 1 also contains the position information 62 in a multiplexed fashion so that the position information 62 on the plurality of recording layers 20, 22, 24, and 26 is recorded on the lead-in areas 94 of all the recording layers. Thus, even if the position information 62 accidentally fails to be read from a certain recording layer, it can be read from other recording layers.

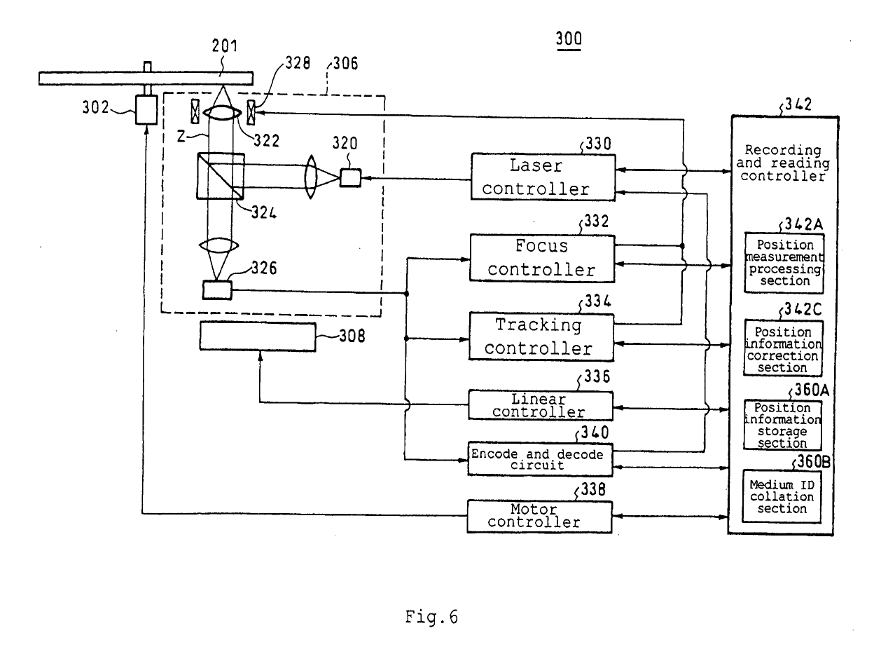

An optical recording medium 201 and an optical recording and reading apparatus 300 for practicing the optical recording and reading method according to a second embodiment of the present invention will now be described with reference to FIG. 6. In the following description and drawings of the optical recording medium 201 and the optical recording and reading apparatus 300, structures, members, and the like similar or identical to those of the optical recording medium 1 and the optical recording and reading apparatus 100 described in the first embodiment will be designated with reference numerals having the same two lower digits. A detailed description thereof will be omitted.

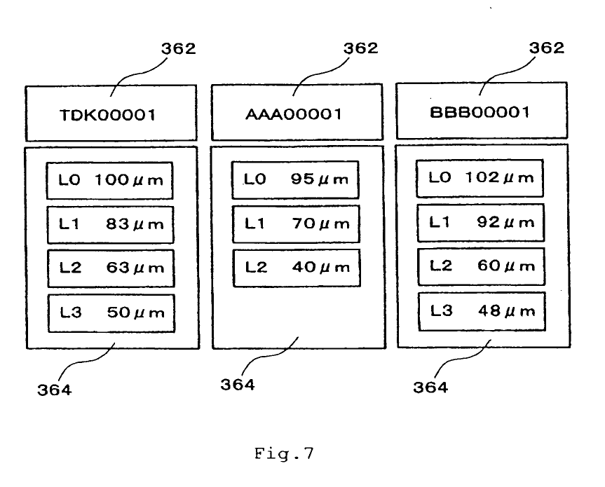

An optical recording and reading controller 342 of this optical recording and reading apparatus 30 includes a position measurement processing section 342A and a position information correction section 342C. Instead of the position information acquisition section of the first embodiment, the optical recording and reading controller 342 further includes a position information storage section 360A and a medium ID collation section 360B. As shown in FIG. 7, the position information storage section 360A stores identification information 362 on a plurality of optical recording media and position information 364 on the recording layers of the optical recording media corresponding to the identification information 362 in the storage means. The identification information 362 is manufacturer-provided information for identifying the type of optical recording medium. It is composed of identification information regarding the manufacturer itself, combined with ID or the like for identifying each individual recording medium. The position information 364 describes the positions of a plurality of recording layers included in each optical recording medium from a light incident surface. The identification information 362 and the position information 364 can be updated externally.

The medium ID collation section 360B reads identification information from an optical recording medium that has been mounted. Based on this identification information, it then acquires the same identification information 362 and the corresponding position information 364 stored in the position information storage section 360A. This makes it possible to recognize the position information 364 on the recording layers of the optical recording medium in advance.

A description will now be given of the optical recording medium 201. As in the first embodiment, this optical recording medium 201 is configured to include L0 to L3 recording layers 220, 222, 224, and 226. The distance from the light incident surface 238A to the L3 recording layer 226 is approximately 50 am. The distance from the light incident surface 238A to the L2 recording layer 224 is approximately 63 μm. The distance from the light incident surface 238A to the L1 recording layer 222 is approximately 83 μm. The distance from the light incident surface 238A to the L0 recording layer 220 is approximately 100 μm. The L0 recording layer 220, or basic recording layer, is located at a position in the range of 90 μm to 110 μm away from the light incident surface 238A, and has a recording capacity of 25 GB. The basic recording layer thus complies with Blu-ray Disc standards.

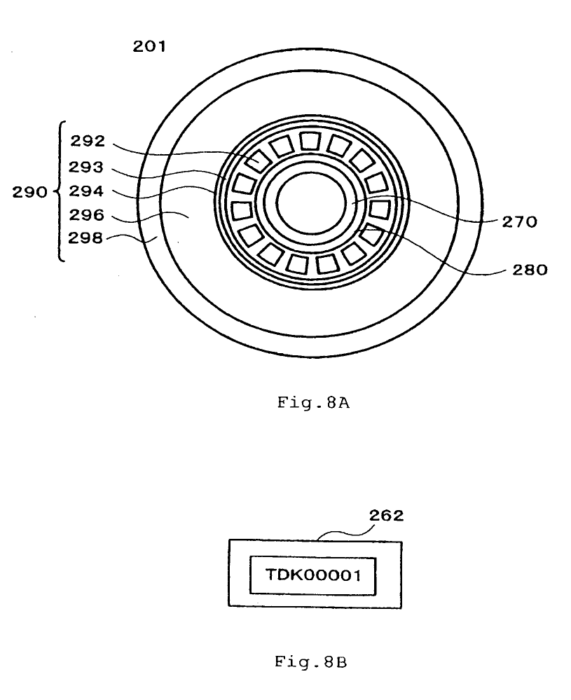

As shown in FIG. 8A, the recording layers 220, 222, 224, and 226 of the optical recording medium 201 each have an information area 290 which includes a dedicated measurement area 293, a lead-in area 294, a data area 296, and a lead-out area 298. The information area 290 of the L0 recording layer 220 alone has burst cutting areas (BCAs) 292 on its innermost side. As shown in FIG. 8B, this optical recording medium 201 contains identification information 262 which is recorded on the BCAs 292 of the L0 recording layer 220. The identification information 262 is intended to identify both the manufacturer of the optical recording medium 201 and the type of the optical recording medium itself. While the present embodiment deals with the case where the position information 262 is recorded on the BCAs 292, it may also be recorded on the lead-in area 294 or on the lead-out area 298.

A description will now be given of the method by which this optical recording and reading apparatus 300 optically records and reads information on/from the optical recording medium 201.

When the optical recording and reading controller 342 receives recording information from a host computer, the medium ID collation section 360B reads the BCAs 292 in the information area 290 of the L0 recording layer 220 in order to acquire the identification information 262. Based on this identification information 262, the medium ID collation section 360B refers to the same identification information 362 and the corresponding position information 364 stored in the position information storage section 360A. As a result, the optical recording and reading apparatus 300 can obtain the position information 364 of all the recording layers 220, 222, 224, and 226 of the optical recording medium 201 in advance.

Then, the position measurement processing section 342A measures the positions of the respective recording layers 220, 222, 224, and 226. Specifically, the objective lens 322 is positioned radially with respect to the dedicated measurement areas 293 of the optical recording medium 200 before it is moved in the direction of the optical axis. With the movement of the objective lens 322, the beam spot of the laser light Z shifts in the stacking direction from the L0 recording layer 220 to the L3 recording layer 226. The resulting intensity signal and focus error signal are transmitted from the photo-detection device 326 and the focus controller 332 to the position measurement processing section 342A. These pieces of information are used to detect the measured positions of the respective recording layers 220, 222, 224, and 226.

The position information correction section 342C calculates the corrected position information by utilizing both the position information 364 extracted by the medium ID collation section 360B and the measured positions of the respective recording layers 220, 222, 224, and 226 acquired by the position measurement processing section 342A.

When starting recording information on an intended recording layer, the objective lens 322 is focus-controlled in the direction of the optical axis based on the corrected position information acquired in advance, so that the laser light z comes into focus on this recording layer. Use of the positions that are acquired through the actual measurement of the optical recording medium 201 allows precise focusing from the beginning of the process. This can significantly reduce the focus time. Then, the intended recording layer is subjected to a test recording operation. After completion of the test, the optical pickup 306 is positioned on the recording track to start recording from, and recording is then started.

Even in this second embodiment, as in the first embodiment, it is possible to perform focus control on the multilayered optical recording medium 201 having three or more layers, i.e., on each of the recording layers 220, 222, 224, and 226 quickly. In particular, the position information 364 can be acquired more quickly since the identification information 262 that is actually recorded on the optical recording medium 201 is collated along with the identification information 362 and the position information 364 which are recorded in the optical recording and reading apparatus 300. Since the identification information 262 includes only a small amount of information, it is possible to retain this identification information 262 in the BCAs 292 which can be read with high reliability. Consequently, even with multilayered recording layers, it is possible to acquire the position information 364 with higher reliability.

The foregoing embodiments have exclusively dealt with the cases in which the position information recorded on the optical recording medium is used in addition to the actual measurements of the positions of the recording layers. However, the present invention is not limited thereto. For example, after the optical recording medium is mounted on the optical recording and reading apparatus, the optical recording medium may be scanned in the thickness direction to measure the positions of all the recording layers using the optical pickup. Even in this case, favorable focus control can also be performed on the recording layers using these measured positions alone.

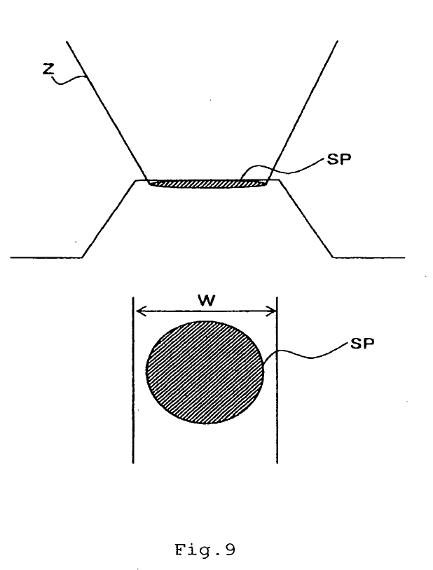

The foregoing embodiments have exclusively dealt with the cases where the dedicated measurement areas of the optical recording medium are totally flat surfaces. However, the present invention is not limited thereto. For example, as shown in FIG. 9, a groove or land that has a width W greater than the diameter of the beam spot SP may be formed so that the positions of the recording layers are measured by using the top or bottom of this groove or land. Moreover, it is not always essential to from the dedicated measurement areas. The lead-in areas or the like may be utilized to measure the positions of the recording layers. The optical recording and reading methods of the embodiments have exclusively dealt with the cases in which the optical recording medium is of recordable type and when recording information on this optical recording medium. The present invention is not limited thereto, however, but can be applied to the cases in which the optical recording medium is of read only type and when reading this optical recording medium. That is, the present invention is not limited to the cases of recording information on an optical recording medium.

It should be appreciated that the optical recording and reading method and its apparatus according to the present invention are not limited to the foregoing embodiments, and various modifications may be made without departing from the gist of the present invention.

The present invention is applicable to various fields where laser light is used for optical recording and reading.

The entire disclosure of Japanese Patent Application No. 2006-345753 filed on 22 Dec., 2006 including specification, claims, drawings, and summary are incorporated herein by reference in its entirety.

What is claimed is:

1. An optical recording and reading method for recording and reading an optical recording medium having three or more recording layers by irradiating the optical recording medium with laser light in an optical recording and reading apparatus, the method comprising the step of measuring positions of the recording layers of an optical recording medium using the laser light when the optical recording medium is mounted on the optical recording and reading apparatus.

2. The optical recording and reading method according to claim 1, wherein an objective lens provided in the optical recording and reading apparatus is moved to shift a beam spot of the laser light in the stacking direction of the layers, thereby measuring the positions of the recording layers using reflected light of the laser light.

3. The optical recording and reading method according to claim 1, wherein an objective lens provided in the optical recording and reading apparatus is moved to shift a beam spot of the laser light in the stacking direction of the layers; and
the positions of the recording layers are measured based on an intensity of the reflected light of the laser light.

4. The optical recording and reading method according to claim 1, wherein an objective lens provided in the optical recording and reading apparatus is moved to shift a beam spot of the laser light in the stacking direction of the layers; and
the positions of the recording layers are measured using a focus error signal pertaining to the laser light.

5. The optical recording and reading method according to claims 1, wherein the recording layers of the optical recording medium have a dedicated measurement area in which the optical recording and reading apparatus measures the positions of the recording layers using the laser light.

6. The optical recording and reading method according to claim 1, wherein the recording layers of the optical recording medium have a dedicated measurement area in which the optical recording and reading apparatus measures the positions of the recording layers using the laser light; and
an objective lens provided in the optical recording and reading apparatus is moved to shift a beam spot of the laser light in the stacking direction of the layers, thereby measuring the positions of the recording layers using reflected light of the laser light.

7. The optical recording and reading method according to claim 1, wherein the recording layers of the optical recording medium have a dedicated measurement area in which the optical recording and reading apparatus measures the positions of the recording layers using the laser light;
an objective lens provided in the optical recording and reading apparatus is moved to shift a beam spot of the laser light in the stacking direction of the layers; and
the positions of the recording layers are measured based on an intensity of the reflected light of the laser light.

8. The optical recording and reading method according to claims 1, wherein the recording layers of the optical recording medium have a dedicated measurement area in which the optical recording and reading apparatus measures the positions of the recording layers using the laser light; and
the dedicated measurement area has a flat surface that is greater than the beam spot of the laser light.

9. The optical recording and reading method according to claims 1, wherein the recording layers of the optical recording medium have a dedicated measurement area in which the optical recording and reading apparatus measures the positions of the recording layers using the laser light;
the dedicated measurement area has a flat surface that is greater than the beam spot of the laser light; and
an objective lens provided in the optical recording and reading apparatus is moved to shift a beam spot of the laser light in the stacking direction of the layers, thereby measuring the positions of the recording layers using reflected light of the laser light.

10. The optical recording and reading method according to claims 1, wherein:
position information on the recording layers of the optical recording medium is recorded on the recording layers in advance; and
when the optical recording medium is mounted, the optical recording and reading apparatus reads the position information recorded on the optical recording medium, and measures the positions of the recording layers as well.

11. The optical recording and reading method according to claims 1, wherein:
position information on the recording layers of the optical recording medium is recorded on the recording layers in advance;
when the optical recording medium is mounted, an objective lens provided in the optical recording and reading apparatus is moved to shift a beam spot of the laser light in the stacking direction of the layers, thereby measuring the positions of the recording layers using reflected light of the laser light; and
the optical recording and reading apparatus reads the position information recorded on the optical recording medium, and measures the positions of the recording layers as well.

12. The optical recording and reading method according to claims 1, wherein:
position information on the recording layers of the optical recording medium is recorded on the recording layers in advance;
when the optical recording medium is mounted, an objective lens provided in the optical recording and reading apparatus is moved to shift a beam spot of the laser light in the stacking direction of the layers, thereby the positions of the recording layers are measured based on an intensity of the reflected light of the laser light; and
the optical recording and reading apparatus reads the position information recorded on the optical recording medium, and measures the positions of the recording layers as well.

13. The optical recording and reading method according to claims 1, wherein:
the optical recording and reading apparatus stores identification information for identifying a plurality of optical recording media and position information on recording layers of the optical recording media in advance;
the identification information is recorded on the optical recording media in advance; and
when an optical recording medium is mounted on the optical recording and reading apparatus, the optical recording and reading apparatus reads the identification information recorded on the optical recording medium and refers to the position information based on the identification information, as well as measures the positions of the recording layers.

14. The optical recording and reading method according to claims 1, wherein:
the optical recording and reading apparatus stores identification information for identifying a plurality of optical recording media and position information on recording layers of the optical recording media in advance;
the identification information is recorded on the optical recording media in advance;
when an optical recording medium is mounted on the optical recording and reading apparatus, an objective lens provided in the optical recording and reading apparatus is moved to shift a beam spot of the laser light in the stacking direction of the layers, thereby measuring the positions of the recording layers using reflected light of the laser light; and
the optical recording and reading apparatus reads the identification information recorded on the optical recording medium and refers to the position information based on the identification information, as well as measures the positions of the recording layers.

15. The optical recording and reading method according to claims 1, wherein:
the optical recording and reading apparatus stores identification information for identifying a plurality of optical recording media and position information on recording layers of the optical recording media in advance;
the identification information is recorded on the optical recording media in advance;
when an optical recording medium is mounted on the optical recording and reading apparatus, an objective lens provided in the optical recording and reading apparatus is moved to shift a beam spot of the laser light in the stacking direction of the layers, thereby the positions of the recording layers are measured based on an intensity of the reflected light of the laser light; and
the optical recording and reading apparatus reads the identification information recorded on the optical recording medium and refers to the position information based on the identification information, as well as measures the positions of the recording layers.

16. An optical recording and reading apparatus for recording and reading an optical recording medium having three or more recording layers by irradiating the optical recording medium with laser light, the apparatus comprising measuring means for measuring positions of the recording layers of an optical recording medium using the laser light when the optical recording medium is mounted on the optical recording and reading apparatus.

17. An optical recording medium having three or more recording layers capable of recording and reading through irradiation of laser light, the recording layers having a dedicated measurement area intended for measuring the positions of the recording layers through the irradiation of the laser light.
